(19) United States
(12) Patent Application Publication
(10) Pub. No.: US 2004/0176991 A1
(43) Pub. Date: Sep. 9, 2004

(54) System, method and apparatus using biometrics to communicate dissatisfaction via stress level

(76) Inventors: Carol McKennan, Fort Collins, CO (US); Evan Kirshenbaum, Mountain View, CA (US); Mark L. Sabiers, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/378,857

(22) Filed: Mar. 5, 2003

(51) Int. Cl. G06F 17/60

(52) U.S. Cl. 705/10

(57) ABSTRACT

The present invention is directed to a responsive online system that monitors a customer's biometric information to measure satisfaction levels. Preferably, the system automatically communicates information about a customer to the online system, without requiring explicit user action. The biometric information measured may be the electrical resistance of the customer's skin, finger pressure, pulse rate, audio or visual images, or other information. Because the system measures the customer's biometric information as the customer uses the online system, the system can respond dynamically and quickly to the user's stress levels.

### CROSS-REFERENCE TO RELATED APPLICATIONS

This application is related to U.S. patent application Ser. No. 10/______, (Attorney Docket No. 200207986-1), entitled “METHOD AND SYSTEM FOR EVALUATING PERFORMANCE OF A WEBSITE USING A CUSTOMER SEGMENT AGENT TO INTERACT WITH THE WEBSITE ACCORDING TO A BEHAVIOR MODEL” to Cipriano SANTOS, et al.; U.S. patent application Ser. No. 10/______, (Attorney Docket No. 200207987-1), entitled “METHOD AND SYSTEM FOR CUSTOMIZED CONFIGURATION OF AN APPEARANCE OF A WEBSITE FOR A USER” to Evan KIRSHENBAUM, et al.; U.S. patent application Ser. No. 10/______, (Attorney Docket No. 200207991-1), entitled “APPARATUS AND METHOD FOR THEOREM CERTIFICATION WITHOUT DISCLOSING DOCUMENTS THAT LEAD TO THE THEOREM” to Mathias SALLE; U.S. patent application Ser. No. 10/______, (Attorney Docket No. 200207993-1), entitled “METHOD AND SYSTEM FOR SELLING AN ITEM OVER A COMPUTER NETWORK” to Evan KIRSHENBAUM, et al.; U.S. patent application Ser. No. 10/______, (Attorney Docket No. 200207994-1), entitled “METHOD AND SYSTEM ENABLING THE TRADING OF A RIGHT TO PURCHASE GOODS OR SERVICES” to Robert C. VACANTE, et al.; U.S. patent application Ser. No. 10/______, (Attorney Docket No. 200207996-1), entitled “METHOD AND SYSTEM FOR PROCESSING USER FEEDBACK RECEIVED FROM A USER OF A WEBSITE” to Mathias SALLE, et al., and U.S. patent application Ser. No. 10/______, (Attorney Docket No. 200309361-1), entitled “A METHOD AND SYSTEM ENABLING THE TRADING OF A FUTURES CONTRACT FOR THE PURCHASE OF GOODS OR SERVICES” to Robert C. VACANTE, et al., all of which are concurrently herewith being filed under separate covers, the subject matters of which are herein incorporated by reference.

### TECHNICAL FIELD OF THE INVENTION

This invention relates generally to the field of online systems management, and more particularly to automated feedback from a user to an online system using biometrics.

### BACKGROUND

Online systems are becoming increasingly useful for businesses. Systems can be used for transactions, e.g., buying or selling merchandise, for internal process maintenance and diagnostics, as general or specific information centers, or for other uses. Typically, an online system is housed on a server and accessed by users or customers using the Internet. The user can access the online system using an internet-enabled device, such as a computer, personal digital assistant (PDA), cellular phone, or other device.

In an online system, users can communicate their satisfaction and dissatisfaction with the format, usability, information or other aspects of the system. This communication may be in the form of a response to a presented survey with questions or it may be a user-initiated communication directed to an email address or telephone number provided by the system.

This method of communication requires the user to perform an explicit action, such as completing survey questions, writing an email message, dialing a telephone, or writing and mailing a letter. However, when a user is dissatisfied with an online system, the user may not wish to perform these actions, or may have forgotten the incident after their session. The online system may not receive any feedback if the method of communication requires explicit action from the user, so the system will not become optimally configured for maximum user satisfaction.

### SUMMARY

The present invention is directed to a responsive online system that monitors a customer's biometric information to measure satisfaction levels. Preferably, the system automatically communicates information about a customer to the online system, without requiring explicit user action. The biometric information measured may be the electrical resistance of the customer's skin, finger pressure, pulse rate, audio or visual images, or other information. Because the system measures the customer's biometric information as the customer uses the online system, the system can respond dynamically and quickly to the user's stress levels.

### DESCRIPTION OF THE DRAWINGS

The features, aspects, and advantages of the present invention will become better understood with regard to the following description, appended claims, and accompanying drawings where:

FIG. 1 depicts a system configuration of an embodiment of the present invention;

FIG. 2 depicts an alternate system configuration of another embodiment of the present invention;

FIG. 3 depicts a flowchart detailing the operation of the system configuration of FIG. 1; and

FIG. 4 depicts a flowchart detailing the operation of the system configuration of FIG. 2.

### DETAILED DESCRIPTION

The present invention uses biometric information from a user to communicate with a remote, online system. The biometric information relays the user's stress levels, indicating if the user becomes dissatisfied with the online system, and thus allowing the online system to respond to the user's dissatisfaction by taking action to alleviate the problem causing the dissatisfaction.

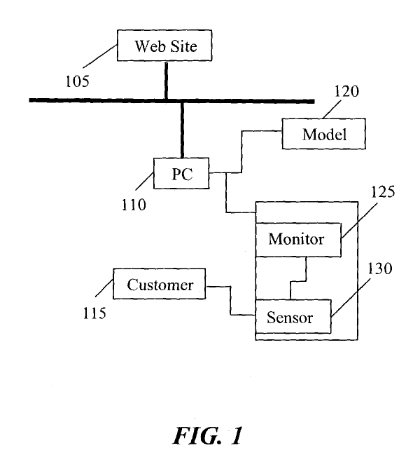

With reference now to FIG. 1 of the Drawings, there is illustrated therein a system configuration of one embodiment of the present invention. The system includes a web site 105, a PC 110, a customer 115, a model of a normal range of values 120, a monitor 125, which uses a model and sensor data to determine a stress level, and a sensor 130, which may be a galvanometer, a pressure-sensitive keyboard, a pressure-sensitive mouse, a stethoscope, a microphone or camera, a blood pressure monitor, a thermometer, etc., which directly contacts the customer 115 to send measurements to the monitor 125.

With reference again to FIG. 1, the customer 115 and the sensor 130 are directly connected. It should be understood that “directly connected” may mean physically connected, intangibly connected, e.g., by video, infrared, or chemical detection, or transiently physically connected, e.g., by a pressure-sensitive device. The sensor 130 sends information to the monitor 125, such as the electrical resistance of the customer's skin, finger pressure, pulse rate, audio or visual images, or other information. The monitor 125 is connected to the customer's computer 110, which has a model 120 of a normal range of responses in memory. The model 120 could be obtained through a variety of techniques known in the art, e.g., the model may be hand-coded by experts, or the model may be found as a result of supervised learning in which people are both monitored and asked to report their stress levels. The data would be used as input to any of several prior art techniques to regress to a model that accurately predicts stress level given the current and historical information. The computer 110 may be any device that the customer 115 can use to access the web site 105, such as a personal digital assistant (PDA), a mobile phone, or a dedicated Internet kiosk. The computer 110 compares the information received from the monitor 125 to the model 120. The physiological information received from the monitor 125 and compared to the model 120 determines the dissatisfaction level of the user. Although the terms dissatisfaction level and stress level are used interchangeably herein, it should be understood that some physiological information correlates to dissatisfaction only and not to stress, and vice versa. After the computer 110 has determined the dissatisfaction or stress level of the user 115, the computer 110 sends the out-of-range physiological information to the web site 105. The web site 105 may be an Internet site, an intranet site, or another remote site.

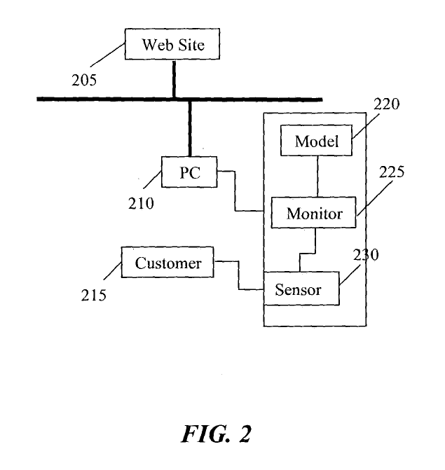

In another embodiment, shown in FIG. 2, there is illustrated an alternate system configuration of the present invention. The system includes a web site 205, a PC 210, a customer 215, a model 220, a monitor 225, and a sensor 230. As in the embodiment of FIG. 1, the sensor 230 may be a galvanometer, a pressure-sensitive keyboard, a pressure-sensitive mouse, a stethoscope, a microphone or camera, a blood pressure monitor, a thermometer, etc. Also as in the embodiment of FIG. 1, the computer 210 may be any device that the customer 215 can use to access the web site 205, such as a PDA, a mobile phone, or a dedicated Internet kiosk.

With reference again to FIG. 2, the customer 215 and the sensor 230 are directly connected. The sensor 230 sends information to the monitor 225, such as the electrical resistance of the customer's skin, finger pressure, pulse rate, audio or visual images, or other information. The monitor 225 has a model 220 of a range of normal responses stored in memory, and the monitor 225 compares the information received from the sensor 230 to the model 220. As in the embodiment of FIG. 1, the model may be determined from any known technique. If the information from the sensor 230 is out of the normal range of the model 220, the monitor 225, which is connected to the customer's computer 210, sends a signal to the computer 210, which sends a signal to the web site 205. As in the embodiment of FIG. 1, the web site 205 may be an Internet site, an intranet site, or another remote site.

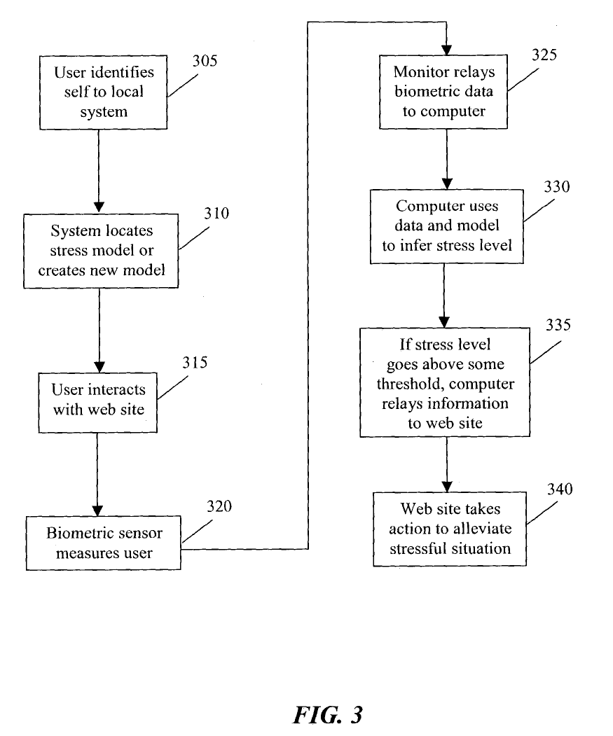

With reference now to FIG. 3, there is illustrated therein a flowchart showing the operation of the system configuration of the embodiment shown in FIG. 1. Initially, the user identifies him or herself to the local network (step 305). This step is optional, and is more useful in a large network environment than when using a single home computer. At the same time, the user may need to connect to the biometric sensor or position him or herself in order to contact the biometric sensor. Next, the system locates an existing stress model or creates a new model (step 310). The stress model may be located on the user's computer or on a remote computer. Also, as noted hereinabove, it should be understood that the stress model includes a range of normal physiological values and may be used to determine both the user's stress level and dissatisfaction level. The user will then interact with the web site (step 315). As the user interacts with the web site, the biometric sensor obtains measurements from the user (step 320). The monitor relays the biometric data to the computer (step 325). The computer compares the biometric data and the model to determine the stress and/or dissatisfaction level of the user (step 330). If the stress and/or dissatisfaction level increases beyond a threshold, the computer will communicate that information to the web site (step 335). It should be understood that the model may be a simple model with a threshold value or may be a more sophisticated model with several rules for triggering an indication of dissatisfaction. For example, the model may include requiring different lengths of time above various threshold values, recognizing particular stress level curves, or noting the frequency of spikes in the stress level. Possibly, in addition to communicating with the web site or as an alternative to communicating with the web site, the computer may adjust the stress model, or the computer may communicate with the user, indicating to the user that the user is experiencing stress or dissatisfaction, or modifying some part of the user's environment, possibly by adjusting audio music and/or volume, etc. Finally, the web site may adjust to alleviate the stressful situation experienced by the user (step 340). In addition to adjusting to alleviate stress, or as an alternative to adjusting to alleviate stress, the web site may mark the particular action or page that induced stress in the user, so that the web site may be altered later.

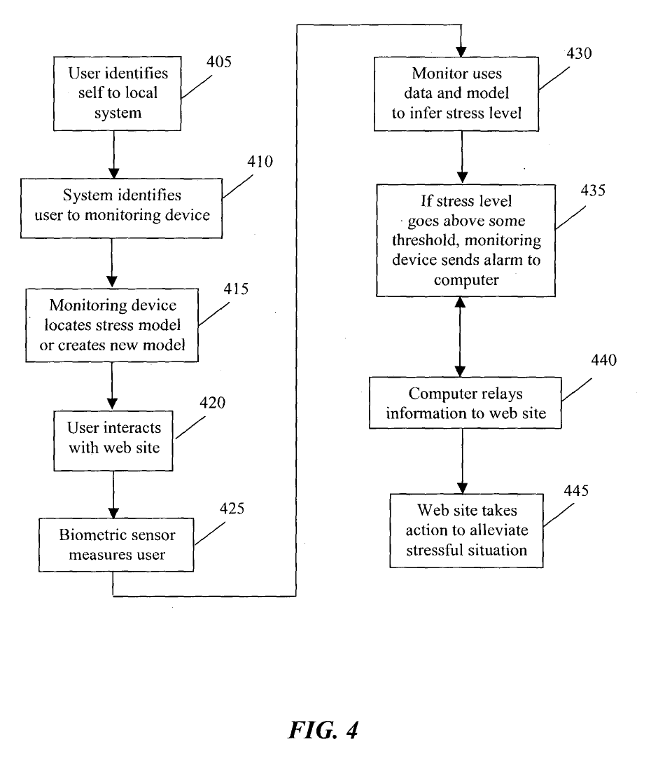

With reference now to FIG. 4, there is illustrated therein a flowchart showing the operation of the system configuration of the embodiment shown in FIG. 2. Initially, as in FIG. 3, the user identifies him or herself to the local system (step 405). This step is more useful in a large network environment than when using a single home computer, and may be omitted. After the user has identified him or herself to the network, the network identifies the user to the monitoring device (step 410). Next, the monitoring device locates an existing stress model or creates a new model (step 415). As in the embodiment described in connection with FIG. 3, the stress model may be located on the user's local computer or may be located on a remote computer. Also, the stress model may be a simple model or may be a more sophisticated model with multiple parameters. The user may need to connect to the monitoring device or position him or herself in order to contact the monitoring device. The user then interacts with the web site (step 420). As the user interacts with the web site, the biometric sensor obtains measurements from the user (step 425). The monitor compares the biometric data and the model to determine the stress and/or dissatisfaction level of the user (step 430). If the stress and/or dissatisfaction level increases beyond a threshold, the monitoring device will communicate that information to the computer (step 435). Then the computer will communicate with the web site (step 440). Possibly, in addition to communicating with the web site or as an alternative to communicating with the web site, the computer may communicate with the user, indicating to the user that the user is experiencing stress, or modifying some part of the user's environment, possibly by adjusting audio music and/or volume, etc. Finally, the web site may adjust to alleviate the stressful situation experienced by the user (step 440). In addition to adjusting to alleviate stress, or as an alternative to adjusting to alleviate stress, the web site may mark the particular action or page that induced stress in the user, so that the web site may be altered later.

The main traditional biometric sensors are pulse rate, blood pressure, body temperature, galvanomic skin response, and breathing rate. More advanced sensors might be brainwave measurements or composition of exhalation gasses or detecting glandular secretions. If there is a camera pointed at the face, there is also the possibility of recognizing stressful facial expressions and changes in skin color, as well as reading information from the dilation of the pupils. A keyboard could note typing pressure and a mouse could sense hand tremor and could note click pressure. Another input device could be a specialized “whomp button”, or punchable monitor, which measures the force of a user's impact and incidentally serves as a stress relief device.

In addition, the system may monitor the environment around the user, especially the light and/or sound levels, to attempt to correctly attribute stress. That is, when an elevated stress level has been detected while a task is being performed, the system may decide whether that stress is due to the task or due to some local stressor. If the latter, then the information would not be sent to the web site, as the web site would not be responsible.

The system may further have some means of controlling the local environment, and may take action to reduce a detected elevated stress level. This may be in addition to or, in lieu of, communicating with the remote site. Such modifications might include the selection of music or control of volume level, change in light level, direction, or type, change in temperature, change in atmospheric gas mixture, or change in seat adjustment. More specifically, modifying the interaction might take the form of, for example, altering the complexity of presentation, changing the color scheme or linguistic register, reducing the amount of animation, or becoming more proactive about suggesting what the user is to do next.

The web site server might be able to modify the interaction or allocate more resources if it can discover what the problem is. Or it might simply log the information that the interaction was stressful for later off-line, perhaps manual, modification.

Also, the system may display a dialog box that says, for example, “You seem to be getting a bit stressed. Maybe it would be a good idea to take a break.” The system may use a dialog box in order to calibrate the stress model. For example, the user may be able to respond to the dialog box affirmatively or negatively, in order to morel finely tune the model. The system may also or alternatively display a continuous stress level to the user. The continuous stress level display may also be used for calibration, allowing the user to designate particular stress levels as satisfied and dissatisfied, or normal and stressed.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

What is claimed is:

1. A system for communicating user dissatisfaction with a website, said system comprising:
a computer, connected to said website; and
a monitoring device, connected to said computer, said monitoring device having a sensor, said system detecting and communicating user dissatisfaction about said website.

2. The system according to claim 1, wherein said monitoring device is selected from a group consisting of:
a galvanometer, a pressure-sensitive keyboard, a pressure-sensitive mouse, a pressure sensor, a stethoscope, a microphone, a camera, a chemical sensor, a blood pressure monitor, and a thermometer.

3. The system according to claim 1, wherein said computer has a stress level model, and wherein said computer compares information from said monitoring device with said stress level model.

4. The system according to claim 3, wherein said computer sends a message to said website when the comparison indicates an elevated stress level.

5. The system according to claim 1, wherein said monitoring device has a stress level model, and wherein said monitoring device compares information from said sensor with said stress level model.

6. The system according to claim 5, wherein said computer sends a message to said website when the comparison indicates an elevated stress level.

7. The system according to claim 1, wherein said computer sends a user dissatisfaction message to another website.

8. The system according to claim 1, wherein said computer monitors an ambient environment of the user.

9. A method of communicating user dissatisfaction with a website, said method comprising:
obtaining biometric information relating to a user in interaction with a website;
determining a dissatisfaction level of said user by comparing said biometric information against a model; and
deciding that said dissatisfaction level is at an actionable level.

10. The method according to claim 9, wherein said biometric information comprises a variable selected from a group consisting of:
heart rate, blood pressure, pulse rate, galvanic skin response, breathing rate, body temperature, hand tremor, force used when performing an action, skin color, perspiration rate, breath gas composition, facial expression, and utterance volume level.

11. The method according to claim 9, further comprising monitoring said biometric information.

12. The method according to claim 11, wherein said monitoring, said determining and said deciding are performed on a monitoring device, further comprising relaying information relating to the decision to a computer used by said user to communicate with said website.

13. The method according to claim 9, wherein said determining is performed on a computer used by said user to communicate with said website.

14. The method according to claim 9, further comprising relaying information relating to said dissatisfaction level to said website.

15. The method according to claim 14, further comprising said website taking action to attempt to reduce said dissatisfaction level of said user.

16. The method according to claim 15, wherein said action is selected from a group consisting of:
altering the appearance of a web page presented by said website to said user, altering the complexity of presentation, changing the color scheme or linguistic register, altering the amount of animation, and altering an allocation of a resource to said user by said web site.

17. The method according to claim 9, further comprising presenting to said user an indication of the determined dissatisfaction level.

18. The method according to claim 17, further comprising
receiving from said user a response indicative of said user's agreement or disagreement with said indication of the determined dissatisfaction level; and
altering said model based on said response.

19. The method according to claim 9, further comprising communicating said dissatisfaction level together with information identifying said website to a second website.

20. The method according to claim 9, further comprising monitoring environmental information relating to a local physical environment surrounding said user.

21. The method according to claim 20, wherein said environmental information is selected from a group consisting of:
ambient light level, ambient sound level, ambient temperature, and a concentration of an atmospheric gas.

22. The method according to claim 20, wherein said deciding comprises determining whether said dissatisfaction level is due to said local physical environment.

23. The method according to claim 22, further comprising adjusting said local physical environment.

24. The method according to claim 23, wherein said adjusting alters a factor selected from the group consisting of:
selection of background music, volume level, light level, light direction, light type, temperature, atmospheric gas mixture, and seat adjustment.

25. An apparatus for determining a dissatisfaction level of a user of a computer system, said apparatus comprising:
a sensor;
a model;
communications means; and
a computer;
wherein:
said sensor measures biometric information relating to said user of said computer system;
said computer executes a program which determines a dissatisfaction level based on said biometric information and said model; and
said communication means is used to convey information relating to said dissatisfaction level to said computer system.

26. The apparatus according to claim 25, wherein said biometric information comprises a variable selected from a group consisting of:
heart rate, blood pressure, pulse rate, galvanic skin response, breathing rate, body temperature, hand tremor, force used when performing an action, skin color, perspiration rate, breath gas composition, facial expression, and utterance volume level.

27. The apparatus according to claim 25, wherein said sensor is selected from a group consisting of:
a thermometer, a galvanometer, a stethoscope, a microphone, a camera, a sphygmomanometer, a pressure sensor, a chemical sensor, and a vibration sensor.

28. The apparatus according to claim 25, further comprising:
a storage device for storing a plurality of models; and
means for identifying said user;
wherein the identification is used to select said model from said plurality of models.

29. The apparatus according to claim 28, wherein the means for identifying is selected from a group consisting of:
means for receiving said identification from said computer system, a keyboard, a tablet, a card reader, a fingerprint reader, a voice recognition system, and a face recognition system.

30. The apparatus according to claim 25, further comprising a memory capable of retaining a history of measured biometric information, wherein said program determines said dissatisfaction level based on said history and said model.
